(19) United States
(12) Patent Application Publication
(10) Pub. No.: US 2013/0176718 A1
(43) Pub. Date: Jul. 11, 2013

(54) LUMINOUS CIRCUIT AND LUMINOUS DEVICE HAVING THE SAME

(71) Applicant: TSUNG-LIN YU, CHIAYI COUNTY (TW)

(72) Inventor: TSUNG-LIN YU, CHIAYI COUNTY (TW)

(73) Assignee: LEXTAR ELECTRONICS CORP., HSINCHU (TW)

(21) Appl. No.: 13/452,978

(22) Filed: Apr. 23, 2012

(30) Foreign Application Priority Data
Jan. 6, 2012 (TW) 101100631

(51) Int. Cl. F21V 21/00

(52) U.S. Cl. 362/217.14

(57) ABSTRACT

A luminous circuit and a luminous device having the same are provided. The luminous circuit may include a first conducting wire and a second conducting wire connected to a positive terminal and a negative terminal of a power supply, respectively. The luminous circuit may further include N light-emitting circuits electrically and sequentially coupled between the first conducting wire and the second conducting wire in a parallel connection fashion beginning from a location in proximity of the power supply. Each of the light-emitting circuits corresponds to a light-emitting element, and jth light-emitting element is better than ith light-emitting element in lighting efficiency, wherein 1≦i<j≦N, i, j, and N are integers, and N≧2.

### BACKGROUND OF THE INVENTION

1. Field of the Invention

The instant disclosure relates to a luminous device, and more particularly, to a strip-shaped luminous circuit and a luminous device having the same.

2. Description of Related Art

Light-emitting diodes have been gaining the popularity recently as they are relatively better in performance of life endurance, power consumption, and luminance when compared with traditional light bulbs/tubes.

A conventional light-emitting luminous device includes a strip-shaped light-emitting tube having at least one light-emitting diode-based bulb incorporated therein. The strip-shaped light emitting tube could replace a traditional light tube and be placed on a traditional base of the conventional luminous device. The light-emitting diode-based bulb could include a circuit substrate and multiple light-emitting elements positioned thereon. The circuit substrate includes conducting wires coupled to a power source and conducting wires for grounding the circuit substrate, with the light-emitting elements arranged between the conducting wires coupled to the power source and the conducting wires for grounding the circuit substrate in a parallel fashion. The light-emitting elements are driven by a direct current (DC) power source, with luminance of the light-emitting elements being proportional to currents passing through light-emitting diodes of the light-emitting elements. In other words, when the current that is larger in value passes through the light-emitting element that particular light-emitting element could enjoy a better luminance, compared with its counterpart passed through by the smaller current.

Accordingly, the luminance of the light-emitting diodes at ends of the luminous devices may be less than desired as resistance of the conducting wires that may increase because the light emitting diodes are distant from the power source dictates the values of the currents passing through the light-emitting diodes. As such, the luminance of the light-emitting diodes that are farther from the power source could be reduced and the light-emitting diodes of the reduced luminance may render uniformity of the luminance of the strip-shaped luminous device having the light-emitting diodes problematic.

### SUMMARY OF THE INSTANT DISCLOSURE

The primary objective of the instant disclosure is to provide a luminous circuit. The luminous circuit may include a first conducting wire and a second conducting wire connected to a positive terminal and a negative terminal of a power supply, respectively. The luminous circuit may further include N light-emitting circuits electrically and sequentially coupled between the first conducting wire and the second conducting wire in a parallel connection fashion beginning from a location in proximity of the power supply.

Each of the light-emitting circuits corresponds to a light-emitting element, and jth light-emitting element is better than ith light-emitting element in terms of lighting efficiency, wherein 1≦i<j≦N, i, j, and N are integers, and N≧2.

The instant disclosure further provides a luminous device having a substrate with a luminous circuit disposed thereon. The luminous device may also have a first conducting wire and a second conducting wire connected to a positive terminal and a negative terminal of a power supply, respectively. The luminous device may further include N light-emitting circuits electrically and sequentially coupled between the first conducting wire and the second conducting wire in a parallel connection fashion beginning from a location in proximity of the power supply.

Each of the light-emitting circuits corresponds to a light-emitting element, and jth light-emitting element is better than ith light-emitting element in lighting efficiency, wherein 1≦i<j≦N, i, j, and N are integers, and N≧2.

In order to further the understanding regarding the instant disclosure, the following embodiments are provided along with illustrations to facilitate the disclosure of the instant disclosure.

### BRIEF DESCRIPTION OF THE DRAWINGS

FIG. 1 illustrates a luminous device according to the first embodiment of the instant disclosure;

FIG. 2 illustrates a schematic diagram of another luminous device according to the first embodiment of the instant disclosure;

FIG. 3 shows a simplified circuit diagram of the luminous circuit according to the first embodiment of the instant disclosure;

FIG. 4 is a simplified circuit diagram illustrating the luminous circuit according to the second embodiment of the instant disclosure; and

FIG. 5 is a simplified circuit diagram of the luminous circuit according to the third embodiment of the instant disclosure.

### DETAILED DESCRIPTION OF THE EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

In the following description based on corresponding drawings, same numerals may be employed to refer to the same or similar devices.

### First Embodiment of Instant Disclosure

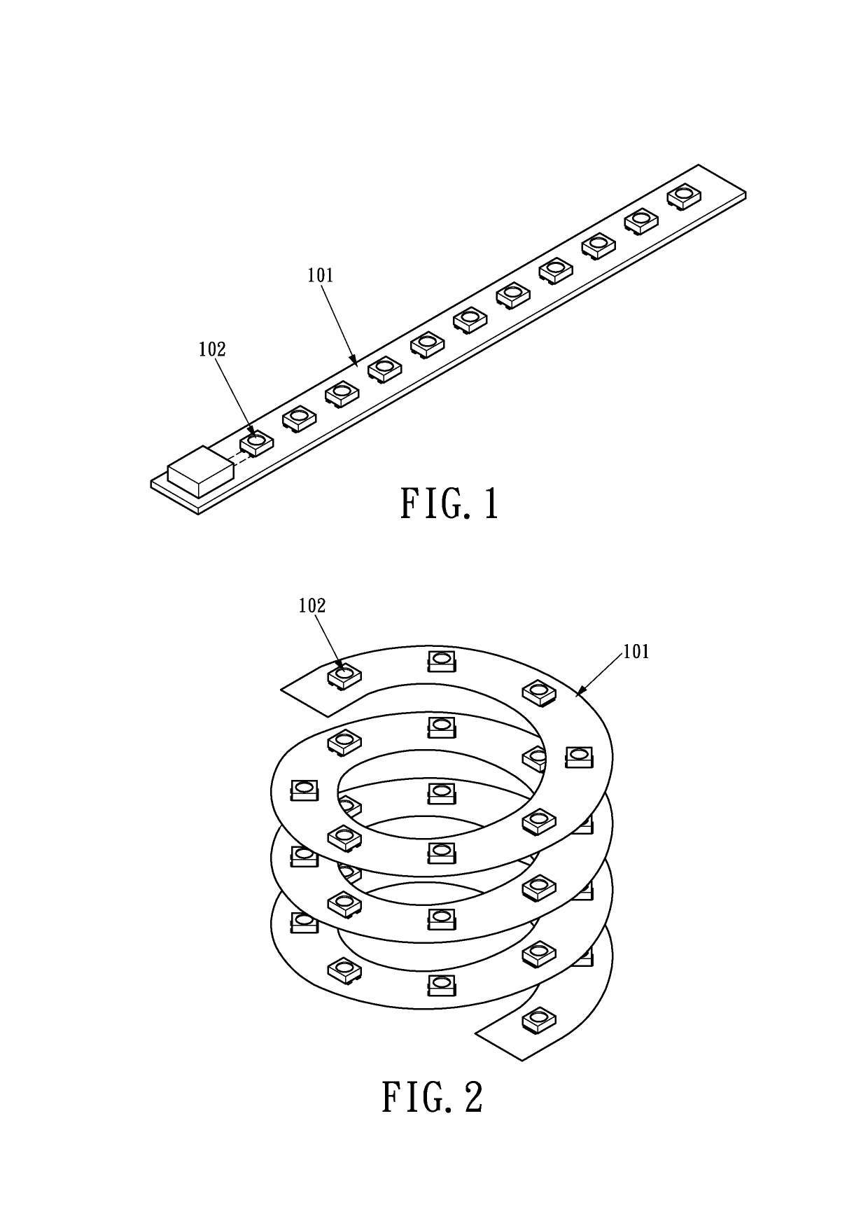

Please refer to FIG. 1 illustrating a luminous device according to the first embodiment of the instant disclosure. The luminous device may include a substrate 101 and a luminous circuit 102. In one implementation, the luminous device may be implemented in terms of a series of luminous circuits. In another implementation, which is shown in FIG. 2 illustrating a schematic diagram of another luminous device according to the first embodiment of the instant disclosure, the luminous device may be a flexible one.

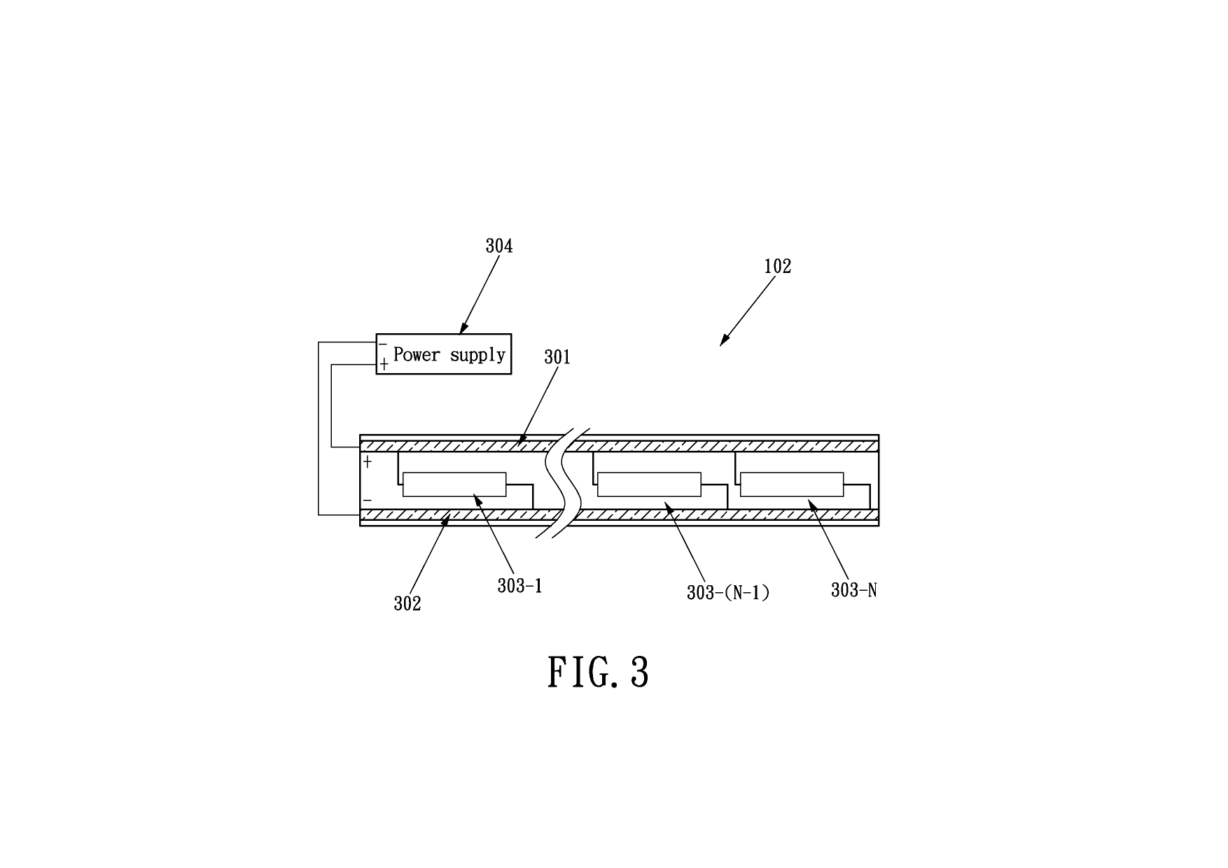

FIG. 3, meanwhile, shows a simplified circuit diagram of the luminous circuit 102 according to the first embodiment of the instant disclosure. The luminous circuit 102 may include a first conducting wire 301, a second conducting wire 302, and multiple light-emitting circuits 303-1 to 303-N. As shown in FIG. 3, a positive terminal of a power supply 304 may be coupled to a left end of the first conducting wire 301 and a negative terminal of the power supply 304 may be coupled to a left end of the second conducting wire 302. The light-emitting circuits 303-1 to 303-N may be electrically coupled and sequentially arranged between the first conducting wire 301 and the second conducting wire 302 in a parallel connection fashion.

It is worth noting that the light-emitting circuits that are farther from the left ends of the first conducting wire 301 and the second conducting wire 302 may be ones associated with better lighting efficiency, which is represented in terms of lm/w (luminance/watt). The light-emitting circuits that are farther from the left ends of the first conducting wires 301 and the second conducting wires 302 may be indicative of those light-emitting circuits are farther from the power supply 304. Accordingly, the light-emitting circuit 303-N may be associated with the best lighting efficiency among all of the light-emitting circuits in FIG. 3.

Theoretically, resistance in the conducting wire 301 and the conducting wire 302 may be overlooked, but in the real world such resistance may render lighting performance (e.g., the luminance) of the light-emitting circuits 303-1 to 303-N non-uniform without the lighting efficiency arrangement provided in the above. Specifically, as the result of the presence of the resistance of the conducting wire 301 and the conducting wire 302, equivalent circuit resistance for the light-emitting circuits that are farther from the left ends of the conducting wires 301 and 302 are larger. Therefore, in the event that the light-emitting circuits 303-1 to 303-N are associated with the same lighting efficiency, the light-emitting circuits that are farther from the conducting wires 301 and 302 may be associated with the lower luminance, which leads to un-uniformity of the lighting performance or the luminance of the light-emitting circuits. On the other hand, when the light-emitting circuits that are farther from the conducting wires 301 and 302 are associated with better lighting efficiency to counter the effect of corresponding larger equivalent circuit resistance the lighting performance in terms of the uniformity may improve.

### Second Embodiment of Instant Disclosure

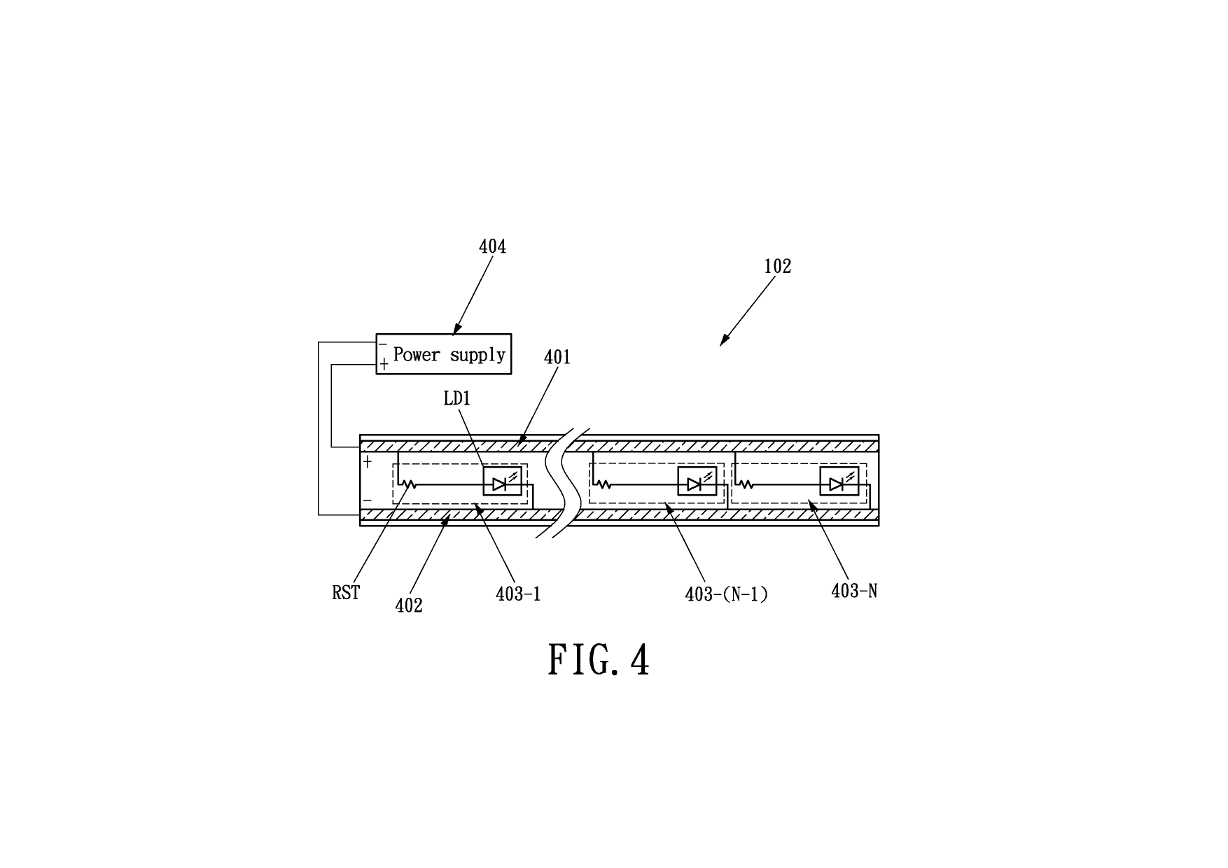

FIG. 4 is a simplified circuit diagram illustrating the luminous circuit 102 according to the second embodiment of the instant disclosure. The luminous circuit in FIG. 4 may include a first conducting wire 401, a second conducting wire 402, and multiple light-emitting circuits 403-1 to 403-N. Similar to the embodiment shown in FIG. 3, a power supply 404 is also provided in the embodiment illustrated in FIG. 4. A positive terminal of the power supply 404 may be coupled to a left end of the first conducting wire 401, while a negative terminal of the power supply 404 may be coupled to a left end of the second conducting wire 402. The light-emitting circuits 403-1 to 403-N may be electrically coupled and sequentially arranged between the first conducting wire 401 and the second conducting wire 402 in a parallel connection fashion. In one implementation, each of the light-emitting circuits 403-1 to 403-N may be implemented in terms of a resistor RST and a light-emitting diode LD1. The light-emitting circuit 403-1 may be the light-emitting circuit in the proximity of the power supply 404, when the light-emitting circuit 403-2 is farther from the power supply 404 when compared with the light-emitting circuit 403-1 and the light-emitting circuit 403-3 is farther from the power supply 404 than the light-emitting circuit 403-2. Accordingly, the light-emitting circuit 403-N may be the light-emitting circuit that is farthest from the power supply among the light-emitting circuits 403-1 to 403-N. It is worth noting that the resistance value of the resistor RST in the light-emitting circuit 403-N may be the smallest among the resistors in all of the light-emitting circuits 403-1 to 403-N for ensuring the luminance uniformity of the luminous circuit 102. For example, the resistance value of the resistor RST of the light-emitting circuit 403-2 is less than the resistance value of the resistor RST of the light-emitting circuit 403-1. And the resistance value of the resistor RST of the light-emitting circuit 403-3 is less than the resistance value of the resistor RST of the light-emitting circuit 403-2.

As the luminance of the light-emitting diode LD1 is generally based on the current value of the current passing through the light-emitting diode LD1, a larger current passing through the light-emitting diode LD1 may correspond to a larger luminance. Therefore, by adjusting the resistance values of the resistors in each of the light-emitting circuits so as to control the current values of the currents passing through the light-emitting diodes LD1 of the light-emitting circuits the lighting efficiency of the light-emitting circuits may be controlled accordingly. Since the light-emitting circuits that are farther from the power supply 404 are associated with resistors in smaller values, the corresponding light-emitting diodes may be better in their lighting efficiency, rendering possible maintaining the uniformity of the performance of light emitting/luminance of the luminous device 102.

Plus, as the resistor RST may serve as a current limiter the corresponding light-emitting diode may be protected from being burned out also.

At the same time, the light-emitting diodes associated with different lighting efficiency may be incorporated into the luminous circuit 102 shown in FIG. 4. For example, the light-emitting circuits that are farther from the power supply 404 may be associated with light-emitting diodes with higher/larger lighting efficiency so as to offset the larger equivalent resistance caused by the larger distance between the light-emitting circuits and the power supply 404. It is worth noting that the light-emitting circuits that are farther from the power supply 404 may be associated with the light-emitting diodes with larger lighting efficiency and resistors smaller in the resistance value. In another implementation, the light-emitting circuits that are farther from the power supply 404 may be associated with the light-emitting diodes with larger lighting efficiency with the resistance values of the resistors thereof remaining the same.

### Third Embodiment of Instant Disclosure

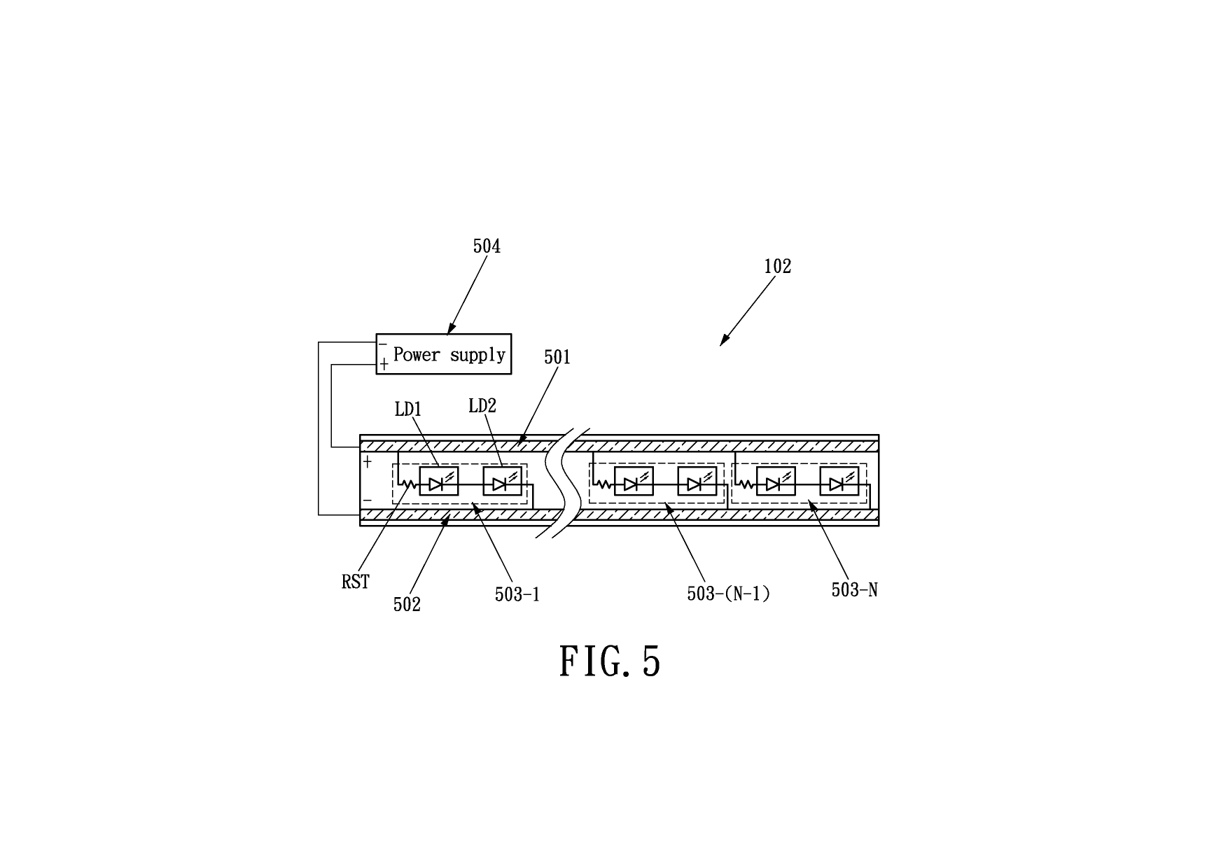

FIG. 5 is a simplified circuit diagram of the luminous circuit 102 according to the third embodiment of the instant disclosure. The luminous circuit 102 here may include a first conducting wire 501, a second conducting wire 502, and multiple light-emitting circuits 503-1 to 503-N. Another power supply 504 is shown for the illustration purpose, with a positive terminal of the power supply 504 coupled to a left end of the first conducting wire 501 and a negative terminal of the power supply 504 coupled to a left end of the second conducting wire 502. Meanwhile, the light-emitting circuits 503-1 to 503-N may be electrically coupled and sequentially arranged between the first conducting wire 501 and the second conducting wire 502 in a parallel connection manner. The light-emitting circuit 503-1 may be the light-emitting circuit in the proximity of the power supply 504, when the light-emitting circuit 503-2 is farther from the power supply 504 compared with the light-emitting circuit 503-1. Also, the light-emitting circuit 503-3 may be the light-emitting circuit that is farther from the power supply 504 when compared with the light-emitting circuit 503-2. As such, the light-emitting circuit 503-N may be the farthest light-emitting circuit from the power supply 504 among all the light-emitting circuits 503-1 to 503-N. In one implementation, each of the light-emitting circuits 503-1 to 503-N may be implemented in terms of a resistor RST, a first light-emitting diode LD1, and a second light-emitting diode LD2.

It is worth noting that the resistance value of the resistor RST in the light-emitting circuit 503-N may be the smallest among the resistors in all of the light-emitting circuits 503-1 to 503-N. In other words, the farther the light-emitting circuits from the power supply 504 the lower the resistance values of their corresponding resistors RST may be.

As the luminance of the light-emitting diodes LD1 and LD2 are generally based on current values of currents passing through the light-emitting diodes LD1 and LD2, larger currents passing through the light-emitting diodes LD1 and LD2 may correspond to larger luminance in the light-emitting diodes LD1 and LD2. Therefore, by adjusting the resistance values of the resistors in each of the light-emitting circuits so as to adjust the currents passing through the light-emitting diodes LD1 and LD2 of the light-emitting circuits the luminance of the light-emitting diodes may be controlled accordingly. Since the light-emitting circuits that are farther from the power supply 504 are associated with resistors in smaller resistance values, the corresponding light-emitting diodes may be better in their lighting efficiency, rendering possible maintaining the uniformity of the performance of luminance of the luminous device 102.

Moreover, as more than one light-emitting diode is incorporated into the light-emitting circuits, the light-emitting circuits may be subject to less likelihood of being burned out.

In summary, since the distance between the light-emitting circuit and the power supply may dictate the resistance value of the equivalent resistance and therefore the current value of the current passing through the light-emitting circuit, adjusting the resistance value of the resistor and the lighting efficiency of the light-emitting diode of the light-emitting circuit may render possible maintaining the uniformity of the luminance. In other words, in the instant disclosure the light-emitting circuits that are farther from the power supply may be equipped with light-emitting diodes associated with better lighting efficiency. Thus, the uniformity of the luminance of the luminous device according to the instant disclosure may be maintained. As such, it is well appreciated that the instant disclosure is suitable to being integrated into light tubes or strip-shaped lights.

The descriptions illustrated supra set forth simply the embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A luminous circuit comprising:
a first conducting wire and a second conducting wire connected to a positive terminal and a negative terminal of a power supply, respectively; and
N light-emitting circuits electrically and sequentially coupled between the first conducting wire and the second conducting wire in a parallel connection fashion beginning from a location in proximity of the power supply;
wherein, each of the light-emitting circuits corresponds to a light-emitting element, and jth light-emitting element is better than ith light-emitting element in terms of lighting efficiency, wherein 1≦i<j≦N, i, j, and N are integers, and N≧2.

2. The luminous circuit according to claim 1, wherein the light-emitting element is a solid-state semiconductor light-emitting element.

3. The luminous circuit according to claim 1, wherein the light-emitting element is a light-emitting diode.

4. The luminous circuit according to claim 1, wherein the light-emitting circuit further comprises a current limiter in a serial connection with the light-emitting element and coupled between the first conducting wire and the second conducting wire.

5. The luminous circuit according to claim 4, wherein the current limiter is a resistor.

6. A luminous device, comprising:
a substrate having a luminous circuit disposed thereon;
a first conducting wire and a second conducting wire coupled to a positive terminal and a negative terminal of a power supply, respectively; and
N light-emitting circuits electrically and sequentially coupled between the first conducting wire and the second conducting wire in a parallel connection fashion beginning from a location in proximity of the power supply;
wherein, each of the light-emitting circuits corresponds to a light-emitting element, and jth light-emitting element is better than ith light-emitting element in terms of lighting efficiency, wherein 1≦i<j≦N, i, j, and N are integers, and N≧2.

7. The luminous circuit according to claim 6, wherein the light-emitting element is a solid-state semiconductor light-emitting element.

8. The luminous circuit according to claim 6, wherein the light-emitting element is a light-emitting diode.

9. The luminous circuit according to claim 6, wherein the light-emitting circuit further comprises a current limiter in a serial connection with the light-emitting element and coupled between the first conducting wire and the second conducting wire.

10. The luminous circuit according to claim 9, wherein the current limiter is a resistor.
